(19) United States
(12) Patent Application Publication
(10) Pub. No.: US 2025/0245052 A1
(43) Pub. Date: Jul. 31, 2025

(54) SYSTEMS AND METHODS FOR SCHEDULING VIRTUAL FUNCTIONS

(71) Applicants: Advanced Micro Devices, Inc., Santa Clara, CA (US); ATI Technologies ULC, Markham (CA)

(72) Inventors: Yinan Jiang, Markham (CA); Chang HaiJun, Shanghai (CN)

(73) Assignees: Advanced Micro Devices, Inc., Santa Clara, CA (US); ATI Technologies ULC, Markham (CA)

(21) Appl. No.: 17/955,455

(22) Filed: Sep. 28, 2022

(51) Int. Cl. G06F 9/50

(52) U.S. Cl. CPC G06F 9/5038; G06F 9/5044; G06F 2209/501

(57) ABSTRACT

The disclosed computer-implemented method can include (i) receiving a plurality of submissions from respective virtual functions requesting at least some resources from a hardware accelerator, (ii) scheduling, by a scheduler, divisions of the resources to the respective virtual functions based on a total actual execution time slice of each respective virtual function, and (iii) allocating the divisions of the resources to the respective virtual functions according to the scheduling. Various other methods, systems, and computer-readable media are also disclosed.

### BACKGROUND

Virtual functions within a virtualization environment can submit workload requests to a hardware accelerator, such as a graphics processing unit. Nevertheless, related technologies do not necessarily optimize the scheduling of provisioning resources from the hardware accelerator to the requesting virtual functions.

### BRIEF DESCRIPTION OF THE DRAWINGS

The accompanying drawings illustrate a number of example implementations and are a part of the specification. Together with the following description, these drawings demonstrate and explain various principles of the present disclosure.

FIG. 1 shows a flow diagram of an example method for scheduling virtual functions.

FIG. 2 shows a first portion of an example timing chart for scheduling virtual functions.

FIG. 3 shows a second portion of the example timing chart for scheduling virtual functions.

FIG. 4 shows a third portion of the example timing chart for scheduling virtual functions.

FIG. 5 shows a first portion of a more detailed version of the example timing chart for scheduling virtual functions.

FIG. 6 shows a second portion of the more detailed version of the example timing chart for scheduling virtual functions.

FIG. 7 shows an example flow diagram for another method for scheduling virtual functions.

FIG. 8 shows a first example system that can facilitate the scheduling of virtual functions.

FIG. 9 shows a second example system that can facilitate the scheduling of virtual functions.

Throughout the drawings, identical reference characters and descriptions indicate similar, but not necessarily identical, elements. While the example implementations described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to systems and methods for scheduling virtual functions. This application generally discloses a Latency Aware Priority Scheduler (“LAPS”), as further discussed herein, which is a novel method of achieving fairness on multiple virtual function time-sliced graphics virtualization technologies by a combination of software, hardware, and firmware. On the software side, the hypervisor can build a list of candidate virtual functions to be run on a hardware accelerator on a given timeframe based on statistics and profiling dynamically collected by the firmware and/or software, as well as the scheduling policy controlled by the scheduler.

The subject matter disclosed herein seeks to solve various deficiencies of hardware accelerator (e.g., GPU) virtualization algorithms that rely on time-slicing available resources and have unbounded and relatively long context switch latency. For example, the disclosed subject matter can ensure that accelerator processing power is evenly split on multiple virtual functions without wasting resources and generating high input latency. Previously, a single virtual function could impact the performance of additional virtual machines if this virtual function submitted a long running shader that could not be effectively pre-empted. This, in turn, could negatively impact the additional virtual machines and/or degrade overall quality of service. Prior attempts to mitigate these negative impacts have not been successful since they often punish the entire set of clients (e.g., by forcing an accelerator reset) or create a situation in which the system is continuously compensating for the behavior of the original virtual machine, which can lead to micro-stuttering.

For example, a liquid mode is a related technology in which virtual functions are free to submit work. Liquid-mode solutions, however, do not attempt to mitigate the performance of each virtual function. As such, performance is not predictable as it depends on other users in connection with the graphics processing unit.

In addition, in a fixed-mode approach, each virtual function is given a fixed time-slice and any overruns involve a reset of the virtual function. While performance can be predictable, there is high scheduling latency and wasted resources. The fixed-mode approach is thus highly unstable and often leads to multiple resets, which makes this approach unsuitable for gaming as a service and/or for computational workloads.

Fairness-mode approaches can also apply fixed scheduling by having a scheduler compensate by deducting a time slice from future scheduling, as further discussed below. This approach, however, generally does not perform statistics work and often results in high latency, poor utilization, and micro-stuttering when attempting to compensate for this delay.

In general, the subject matter disclosed herein can improve upon related technologies by scheduling submissions from virtual functions based on a total actual execution time, as discussed further below. For example, a computer-implemented method for scheduling virtual functions can include receiving a plurality of submissions from respective virtual functions requesting at least some resources from a hardware accelerator, scheduling, by a scheduler, divisions of the resources to the respective virtual functions based on a total actual execution time slice of each respective virtual function, and allocating the divisions of the resources to the respective virtual functions according to the schedule.

In some examples, the method further includes scheduling a first submission from a first virtual function based on the first virtual function having a lowest total actual execution time slice among the respective virtual functions.

In some examples, the method further includes scheduling a first submission from a first virtual function based on both the first virtual function having a smallest actual incremental time slice and a remainder of the virtual functions having the same total actual execution time slice.

In some examples, the method further includes scheduling a first submission from a first virtual function based on both the first virtual function having been scheduled first and based on a remainder of the virtual functions having the same total actual execution time and having the same detected incremental time slice.

In some examples, an actual incremental time slice for a first virtual function is ascertained by a hardware or firmware component.

In further examples, the actual incremental time slice for the first virtual function deviates from a designated incremental time slice that was previously assigned to the first virtual function.

In some examples, the actual incremental time slice deviating from the designated incremental time slice causes the hardware accelerator to idle.

In some examples, the hardware or firmware component reports the actual incremental time slice to the scheduler.

In some examples, the scheduler schedules a frequency of granting a division of the resources to a first virtual function based on a size of a respective submission from the first virtual function.

In some examples, the scheduler iteratively executes, during a cycle of the hardware accelerator, a function that updates the total actual execution time of each respective virtual function until a condition is met.

In addition, this application discloses a non-transitory computer-readable medium including one or more computer-executable instructions that, when executed by at least one processor of a computing device, cause the computing device to perform the method that is outlined above.

Similarly, in addition, this application discloses a hardware accelerator that is configured to perform the method that is outlined above.

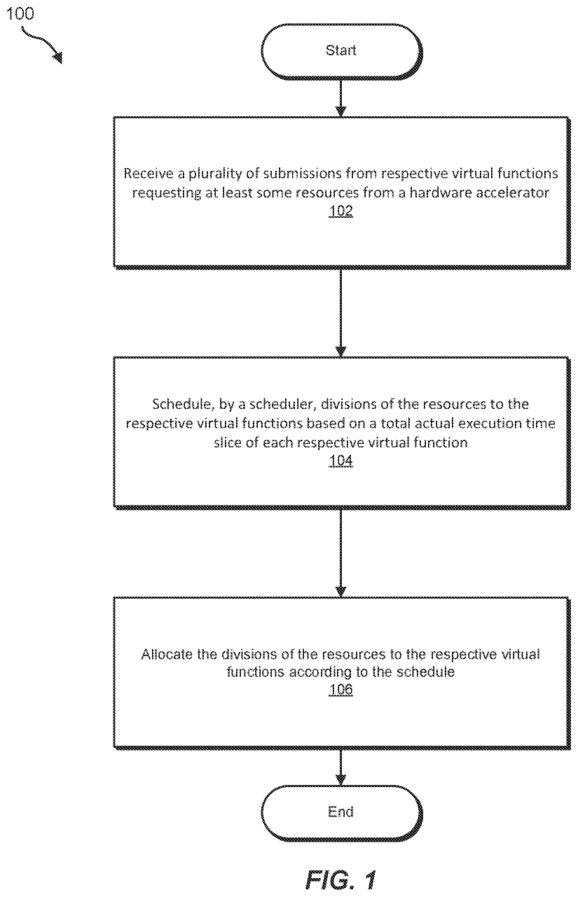

FIG. 1 is a flow diagram of an example computer-implemented method 100 for scheduling virtual functions. The steps shown in FIG. 1 can be performed by any suitable computer-executable code and/or computing system. In one example, each of the steps shown in FIG. 1 can represent an algorithm whose structure includes and/or is represented by multiple sub-steps, examples of which will be provided in greater detail below.

At step 102, one or more of the systems described herein can receive a plurality of submissions from respective virtual functions requesting at least some resources from a hardware accelerator. Step 102 can be performed in a variety of ways. As further discussed above, virtual functions within a virtualization environment can require or request one or more instances of resources from a hardware accelerator, such as a graphics processing unit. Nevertheless, the hardware accelerator might only be configured to process one virtual function submission at a time, as discussed further below.

As used herein, the term “submission” can refer to a request for consumption of resources, as further discussed below. Moreover, as used herein, the term “hardware accelerator” can refer to a peripheral device or other hardware component that supplements the computational power of a primary processor or central processing unit.

Generally speaking, step 102 can be performed in the context of a hardware accelerator, such as a graphics processing unit, receiving a request from a virtual function within a virtualization environment. In some examples, virtual functions within a virtualization environment can submit requests for processing, and it can be more efficient and advantageous to have these submissions processed by a processor, such as a hardware accelerator, rather than by the central processing unit of a corresponding computing system. Nevertheless, in some scenarios the hardware accelerator can only be configured to process one submission from a virtual function at a time. Accordingly, the hardware accelerator can benefit from a scheduler that intelligently schedules one or more submissions to be processed from respective virtual functions across a cycle. In other words, over a cycle for the hardware accelerator, the scheduler can assign or allocate resources from the hardware accelerator to different ones of the virtual functions, according to the order and the prioritization scheme that the scheduler has established.

At step 104, one or more of the systems described herein can schedule, as part of a scheduler, divisions of the resources to the respective virtual functions based on a total actual execution time slice of each respective virtual function. And furthermore, at step 106, one or more of the systems described herein can allocate the divisions of resources (e.g., according to step 104) to the respective virtual functions according to the schedule. Steps 104-106 can be performed in a variety of ways.

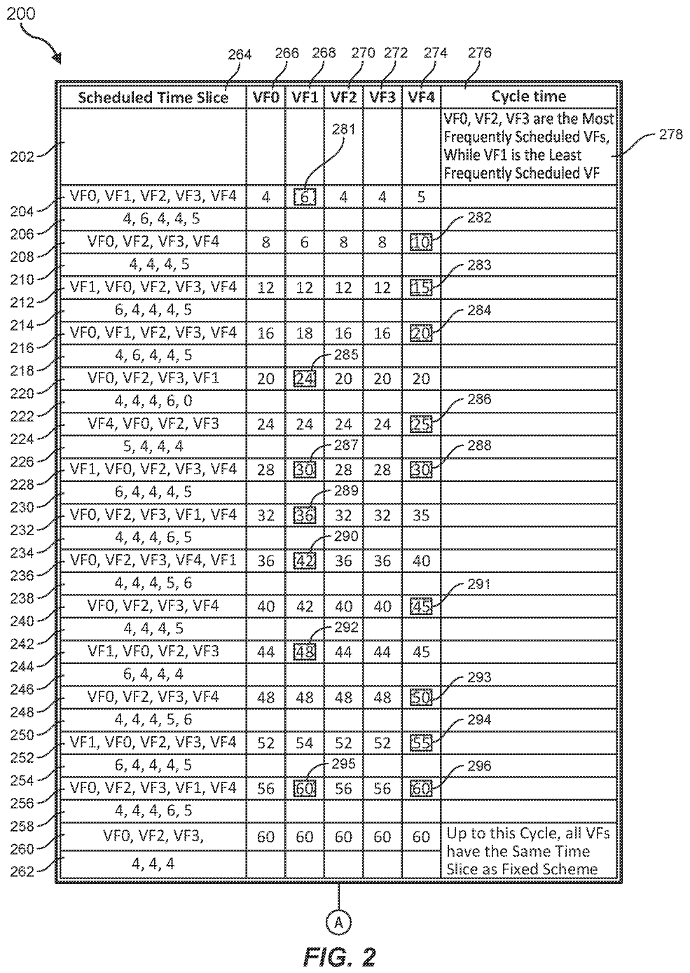

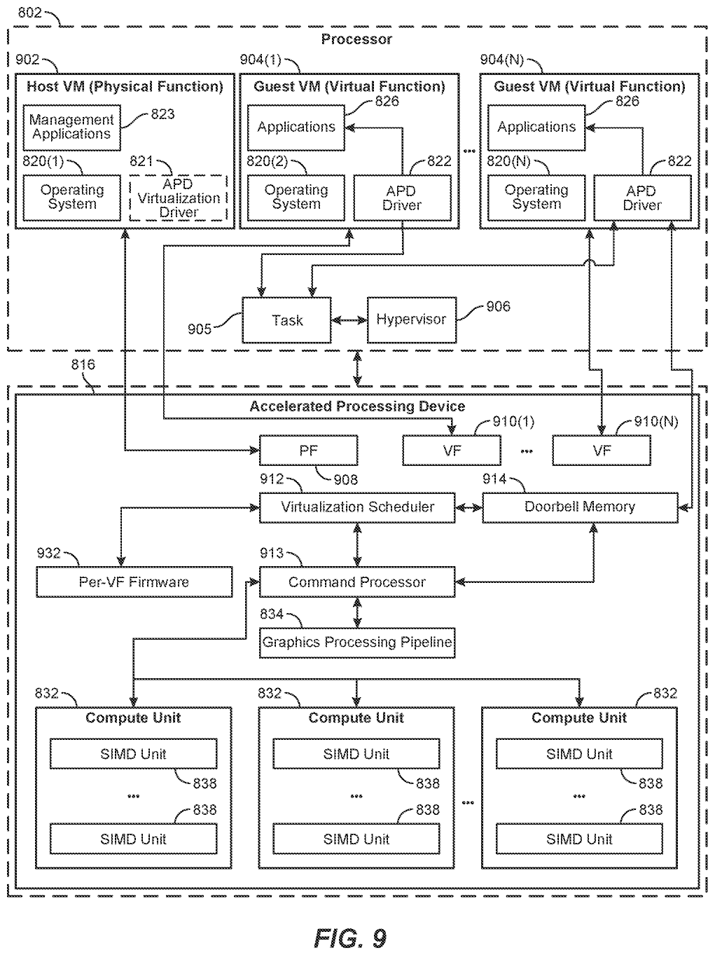

As used herein, the term “scheduler” can refer to any hardware, software, firmware, virtualization, or other component that can perform, or facilitate the performance of, method 100, consistent with the discussion below. By way of example, FIG. 9 shows an illustrative virtualization scheduler 912 within an accelerated processing device 816, although the scheduler can also, or alternatively, be implemented within APD virtualization driver 821 of FIG. 9. As used herein, the term “virtual function” can refer to any programming or other function that can request the consumption of resources from a hardware accelerator consistent with method 100 and FIGS. 2-7, for example. The virtual function can request the consumption of these resources within a virtualization environment in coordination with a hypervisor (see FIG. 9, for example). Furthermore, as used herein, the term “total actual execution time slice” can refer to a total or running total amount of time that a hardware accelerator has actually executed for a particular virtual function, as distinct from an apparent or designated amount of time that could have been allocated or expected for the virtual function, as discussed further below, and consistent with the running total actual execution time values recorded in columns 266-274 in FIGS. 2-6.

In other words, the actual incremental time slice for a virtual function can deviate from a designated incremental time slice that was previously assigned to the first virtual function. This can happen in various ways. For example, an interrupt can indicate that a hardware accelerator executing for a specific virtual function is idling before exhausting a designated incremental time slice allotted to that virtual function, as discussed further below. In some cases, the actual incremental time slice deviating from the designated incremental time slice causes the hardware accelerator to idle. In these examples, a hardware or firmware component can report the actual incremental time slice to the scheduler,

FIGS. 2-4 show illustrative portions of a timing diagram 200-400, which can correspond to how a scheduler can intelligently allocate resources from a hardware accelerator to different submissions from respective virtual functions, as further discussed above. Generally speaking, the scheduler corresponding to these figures can allocate resources from the hardware accelerator to the various virtual functions according to a particular algorithm, which furthermore is consistent with three general principles; namely: (i) the smaller total actual execution time of a virtual function will result in that particular virtual function being assigned the highest priority and being assigned first, (ii) if multiple virtual functions have the same total actual execution time, then the scheduler will schedule the virtual function having the smallest time slice first, as further discussed below, and (iii) in the event that multiple virtual functions have the same total actual execution time and also have the same time slice, then the scheduler will schedule the virtual function that has the oldest scheduled submission to have the highest priority.

Generally speaking, the purpose of the algorithm described herein is to have large kernel submissions receive a long time slice but not be often scheduled, whereas short submissions can obtain short time slices and also be frequently scheduled. In one implementation, a world switch scheduler can schedule virtual functions according to each respective virtual function's priority, where that measurement of priority is determined by a total actual execution time slice for the corresponding virtual function. The scheduler can then schedule each virtual function based on a few principles to achieve the goal, whereby each virtual function obtains its designed hardware accelerator percentage bandwidth.

The detection of each virtual function's actual used time slice can involve input from a hardware or firmware detection configuration during the designated time slice. If the hardware accelerator engine is idle during the designated time slice, a notification or interrupt can be propagated to the scheduler so that the scheduler knows the actual used time slice of this virtual function and can switch to the next virtual function that has a job submission pending.

In the example of FIG. 2, when the designated time slice for each virtual function is 4 ms, the actual execution time slice for VF0, VF2, VF3 is 4 ms, whereas VF1 is 6 ms and VF4 is 5 ms. Beginning from the first world switch cycle, the scheduler can perform a switching scheme based on the three principles that are outlined above and consistent with the timing diagram that is shown within FIG. 2.

As further shown in this figure, timing diagram 200 can include rows 202-262 and columns 264-276. Cell 278 can indicate that three different virtual functions are the most frequently scheduled virtual functions while another virtual function (VF1) is the least frequently scheduled. For this reason, VF1 has the highest total execution time from cell 281. Timing diagram 200 further shows how cells 281, 282, 283, 284, 285, 286, 287, 288, 289, 290, 291, 291, 292, 293, 294, 295, and 296 can indicate that respective virtual functions were scheduled least according to the algorithm described herein.

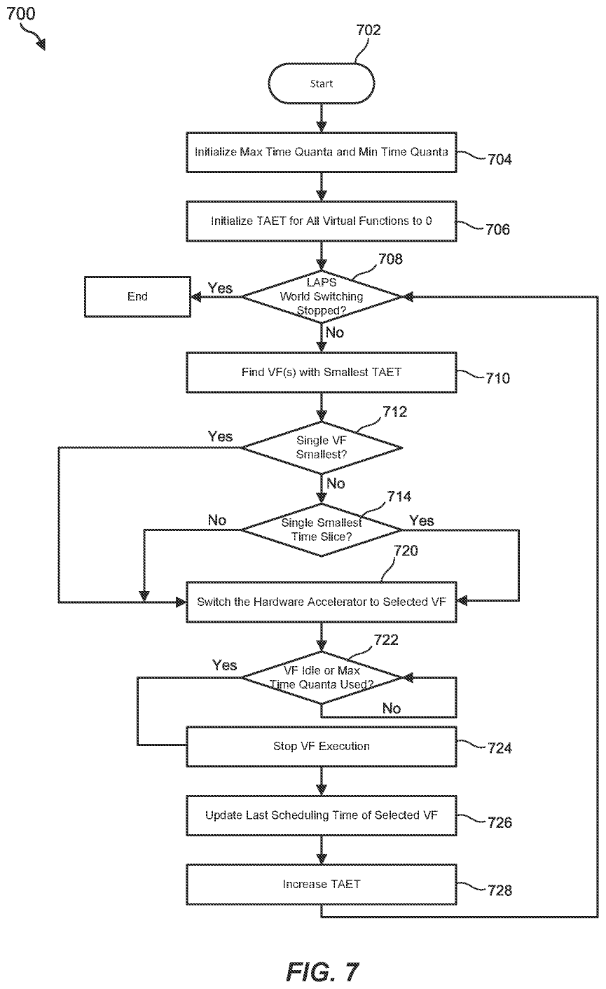

The illustrated timing diagram further shows how, at each cycle corresponding to a row, a combination of three separate principles are applied. The principles indicate that the smaller total actual execution time (“TAET”) of a virtual function will be assigned higher priority and get scheduled first (i.e., the method can further include scheduling a first submission from a first virtual function based on the first virtual function having a lowest total actual execution time slice among the respective virtual functions). If multiple virtual functions have the same TAET, then the algorithm will schedule the smallest time slice virtual function first (i.e., the method can further include scheduling a first submission from a first virtual function based on both the first virtual function having a smallest actual incremental time slice and a remainder of the virtual functions having the same total actual execution time slice). Then, if multiple virtual functions have the same TAET and also have the same time slice, the oldest scheduled virtual function will have the highest priority (i.e., the method can further include scheduling a first submission from a first virtual function based on both the first virtual function having been scheduled first and based on a remainder of the virtual functions having the same total actual execution time and having the same detected incremental time slice). These conditional tiebreaking steps are discussed further below in the context of method 700 in FIG. 7.

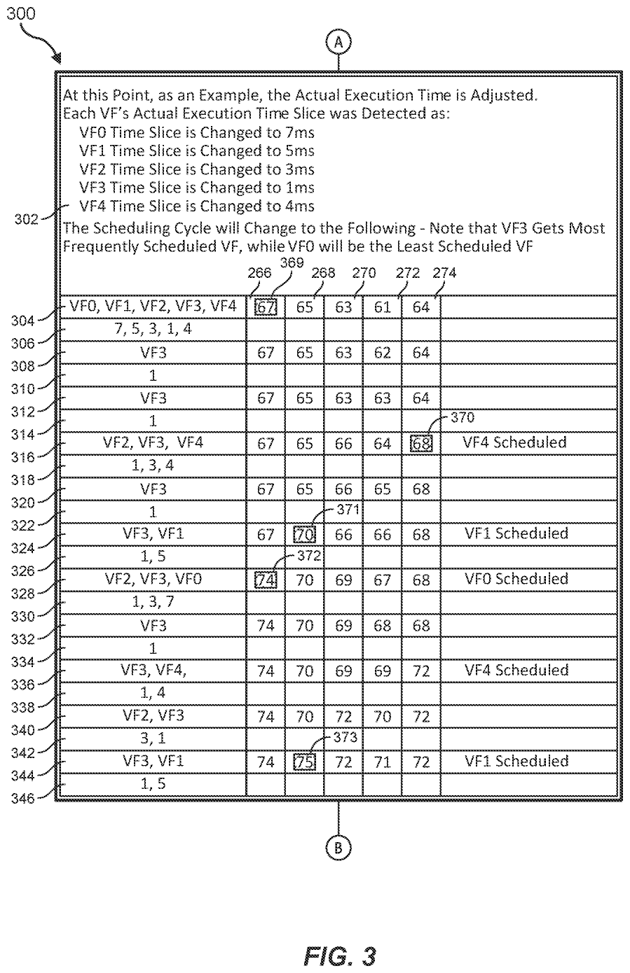

FIG. 3 shows an example timing diagram 300, at which point the firmware or hardware can cause an interrupt to verify the actual execution time for respective virtual functions, which can potentially deviate from the allocated or designated time, as further discussed above. As further shown in this figure, timing diagram 300 can further include rows 304-346, as well as a graphic 302 indicating time slice allocation. Timing diagram 300 further illustrates how certain virtual functions can be scheduled when they have the highest value along a corresponding row. The corresponding cells include cells 369, 370, 371, 372, and 373.

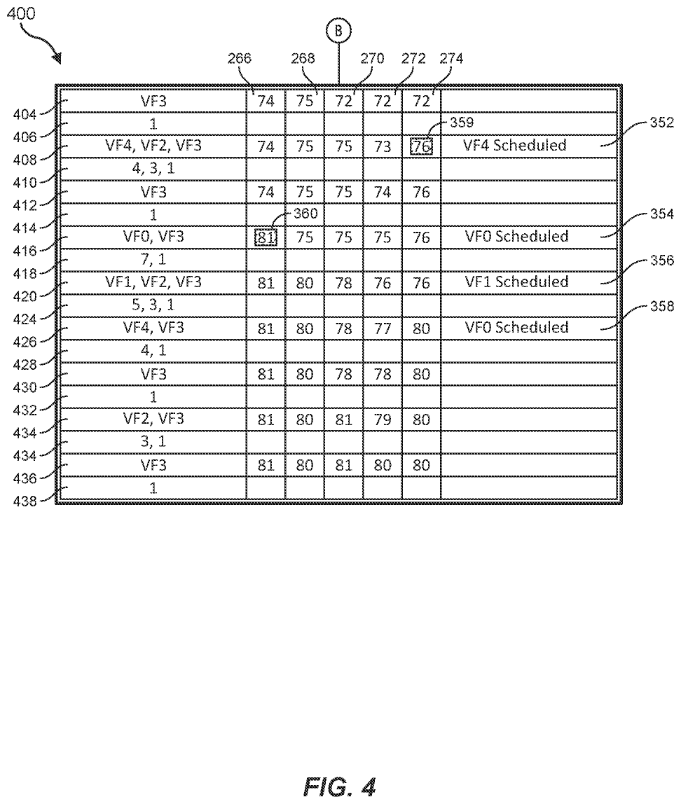

FIG. 4 shows another timing diagram 400 that continues and corresponds to timing diagrams 200-300. Timing diagram 400 can include rows 404-438 and highlight scheduled virtual functions according to cells 359 and 360, as further documented in cells 352, 354, 356, and 358.

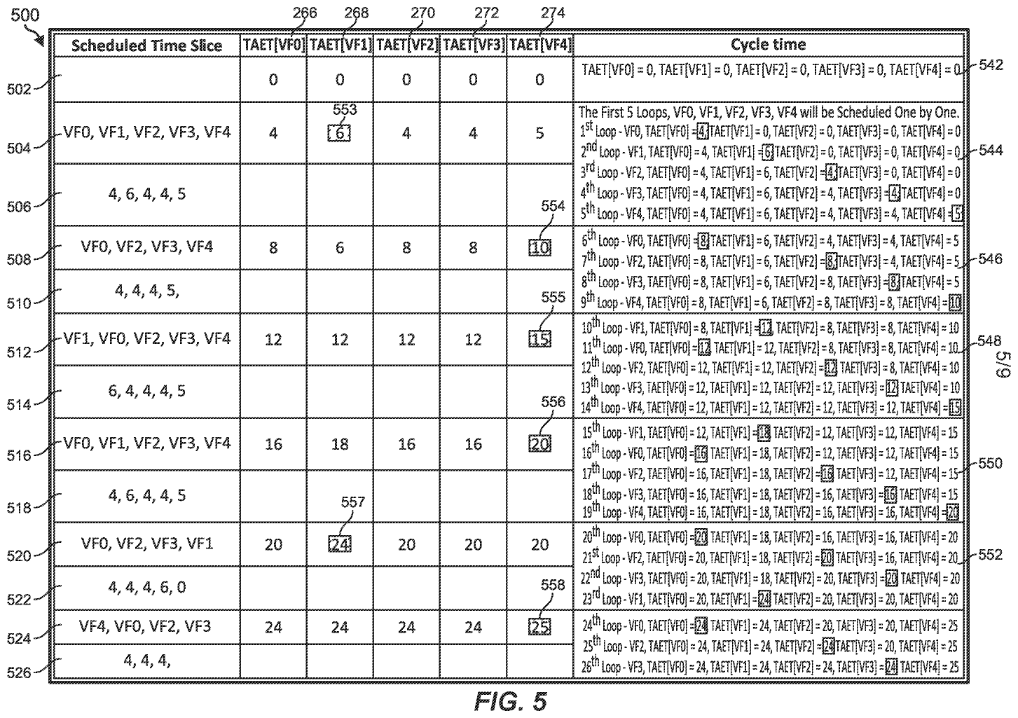

FIG. 5 shows a more detailed version of a portion 500 of timing diagram 200. As further shown in this figure, portion 500 can further include rows 502-526. Moreover, portion 500 further shows cells 542-552, which document intervening intermediate steps at which one or more of the virtual functions can be scheduled according to the algorithm and principles that are outlined above. Consistent with the discussion above, cells 553, 554, 555, 556, 557, and 558 highlight how respective virtual functions have been scheduled, according to the algorithm and principles that are highlighted above, due to the fact that each respective virtual function has the highest value within each respective row.

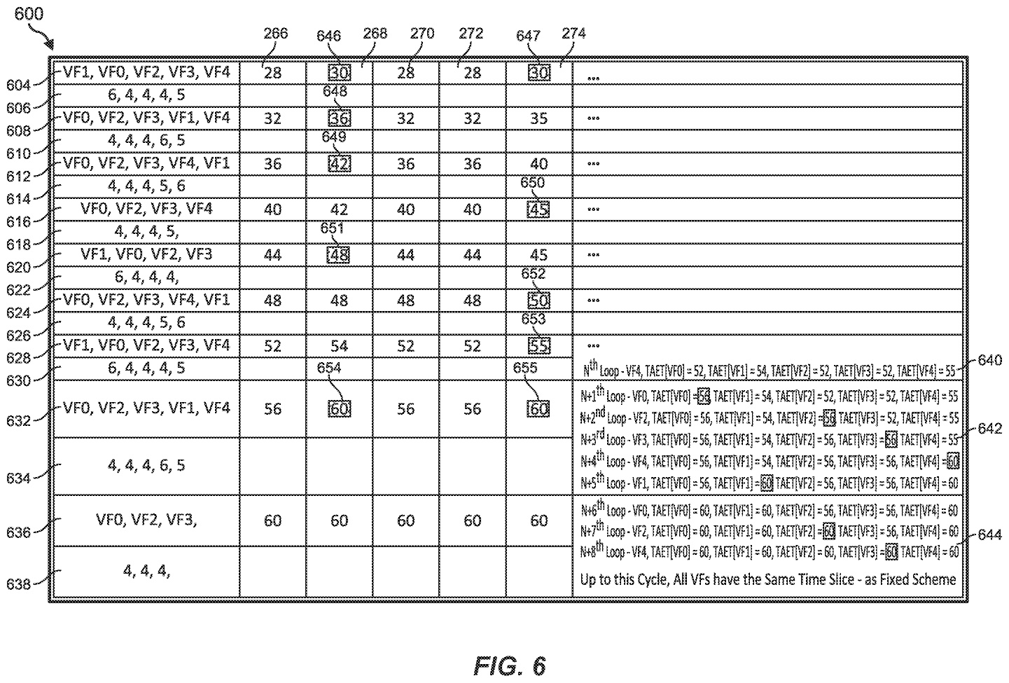

Similarly, FIG. 6 shows another portion 600 of the corresponding timing diagram, including rows 604-638. Portion 600 of the timing diagram further highlights how, at cells 646, 647, 648, 649, 650, 651, 652, 653, 654, and 655, respective virtual functions have been scheduled last, according to the algorithm and principles that are highlighted above, due to the fact that, at each respective row, each virtual function has the value that is the highest within a respective row.

Returning to FIG. 1, at the first cycle corresponding to row 504, five separate loops can be performed in which the five different virtual functions can be scheduled one by one. In the first loop VF0 is allocated 4 ms, in the second loop VF1 is allocated 6 ms, in the third loop VF2 is allocated 4 ms, in the fourth loop VF3 is allocated 4 ms, and in the fifth loop VF4 is allocated 5 ms. This is consistent with the detected actual execution times for these respective virtual functions, as further shown and discussed above in connection with FIG. 2.

After the first cycle, the three principles outlined above can be applied according to the algorithm to fairly and more efficiently allocate resources from the hardware accelerator to the various virtual functions. Accordingly, at the sixth loop (see cell 546), VF0 can be allocated an additional 4 ms, which brings the total actual execution time to 8 ms for this virtual function. At the seventh loop corresponding to cell 546, another 4 ms can be allocated to VF2, which brings the total actual execution time to 8 ms for this virtual function. And at the eighth loop corresponding to cell 546, another 4 ms can be allocated to VF3, which again brings the total actual execution time to 8 ms for this virtual function. These three virtual functions can be allocated an additional 4 ms, consistent with their time slice execution times as detected by the firmware or hardware component, as further discussed above, due to the fact that, at the previous loop (e.g., 5^{th} loop in cell 544), these respective virtual functions have the lowest values in terms of total actual execution time (i.e., 4 ms), and therefore were allocated additional resources from the hardware accelerator as a priority consistent with the first of the three principles that are outlined above (i.e., the smaller total actual execution time of a virtual function will be assigned higher priority and be scheduled first).

After the eighth loop of cell 546, an additional 5 ms can be assigned to VF4 consistent with the three principles that are outlined above. This is due to the fact that, as further discussed above, at the eighth loop, the total actual execution time for this virtual function is the lowest (i.e., 5 ms) from among the values that are shown within cell 546. Accordingly, applying the first of the three principles outlined above again, this particular virtual function will be prioritized first. At this point, the algorithm can proceed to the next cycle of the hardware accelerator, consistent with rows 512-514 of portion 500 shown in FIG. 5. In other words, the three principles continue to be applied in the sixth-ninth loops, such that an additional allotment would not be allocated to VF1 since this particular virtual function was previously scheduled (see cell 553) as having the highest value within the previous cycle (see row 504).

As further shown in FIG. 5, the algorithm can proceed to a cycle, corresponding to rows 512-514, at which point an additional 4 ms can be allocated to VF0, VF2, and VF3. Cell 548 provides additional details regarding inter-cycle loops 10-14, during which individual allocations of hardware accelerator resources are assigned to virtual functions respectively according to the three principles and the algorithm that are outlined above. At the tenth loop, an additional 6 ms are allocated to VF1 (i.e., due to the fact that this particular virtual function has the lowest value from among all of the values corresponding to the ninth loop shown in cell 546). At the eleventh loop, an additional 4 ms is assigned to VF0. At the twelfth loop, an additional 4 ms is assigned to VF2. And at the thirteenth loop, an additional 4 ms is assigned to VF3. These allocations are made in allotments of 4 ms (see FIG. 2) consistent with the actual execution time corresponding to these virtual functions as detected by the firmware or hardware component that is further discussed above. Lastly, at the fourteenth loop, an additional allotment of 5 ms is assigned to VF4, consistent with the original detected actual execution time slice for this virtual function by the hardware or firmware component. (i.e., an actual incremental time slice for a first virtual function is ascertained by a hardware or firmware component). This is due to the fact that, in the previous thirteenth loop, this virtual function had the lowest value from among the set of values for the respective virtual functions. The remaining cycles for rows 516-638 proceed according to the three principles outlined above in the corresponding algorithm in a parallel manner, as further shown in the remainder of FIGS. 5-6.

FIG. 7 shows an example flow diagram corresponding to a method 700 for scheduling virtual functions. Method 700 can be performed by any suitable processor and/or scheduler (e.g., APD virtualization driver 821 and/or virtualization scheduler 912 of FIG. 9, as discussed further below). Method 700 can begin at step 702, and then proceed to step 704, at which point a maximum time quanta and a minimum time quanta can be initialized. Regarding the maximum time quanta, a driver (e.g., APD virtualization driver 821 of FIG. 9, as discussed further below) can force the execution of a corresponding virtual function to stop once it reaches this maximum time quanta, and this forced stopping procedure can be performed even if the virtual function still has a job executing. Regarding the minimum time quanta, the driver can give the virtual function a minimum time quanta even if an underlying hardware or firmware component notifies the driver that the virtual function is already idle.

At step 706, the scheduler can initialize, for each virtual function, a variable to zero where this variable tracks the total actual execution time for each respective virtual function. At step 708, a “do while” loop can begin that will continue until LAPS world switching has stopped (e.g., which can end when virtual functions stop requesting work from the hardware accelerator). In other words, the scheduler can iteratively execute, during a cycle of the hardware accelerator, a function that updates the total actual execution time of each respective virtual function until a condition is met, as further discussed below and consistent with FIG. 7.

From step 708, method 700 can proceed to a step 710, at which point the scheduler can find one or more virtual functions having the smallest total actual execution time from among the set of virtual functions. When a virtual function has a total actual execution time that is the smallest value, this indicates that the corresponding virtual function received the shortest time quanta in the past, and therefore the virtual function should be allocated a time quanta in accordance with a fixed scheme. For example, in FIG. 5 at the sixth loop, VF0, VF2, and VF3 had the smallest total actual execution time of 4 ms, and then were allocated an additional instance of 4 ms in accordance with a fixed allotment scheme,

At step 712, a decision can be performed by the scheduler to decide whether only one virtual function has the smallest total actual execution time, at which point the hardware accelerator can be switched to working for that particular virtual function at step 720. In contrast, at step 714, if multiple virtual functions have the same total actual execution time, then a tiebreaking procedure can be performed by further checking which of these virtual functions will be selected. The tiebreaking procedure can evaluate which of these virtual functions has the single smallest time slice (e.g., where the time slice indicates the incremental time allotment previously assigned to the respective virtual function, such as the time slices shown at graphic 302 in FIG. 3). If a single virtual function has the smallest time slice, then that virtual function can be selected at step 720.

On the other hand, if multiple virtual functions have the same total actual execution time and the same time slice, then a different tiebreaking procedure can be performed, where this tiebreaking procedure simply checks which of these virtual functions was previously scheduled first. In that case, the oldest scheduled virtual function within the set is selected at step 720.

After the hardware accelerator switches to executing the task for the selected virtual function at step 720, the hardware accelerator can continue to work for the selected virtual function in a loop, which corresponds to step 722, until either the hardware/firmware component issues an interrupt notifying the hardware accelerator that the virtual function is idle or the maximum time quanta for that specific virtual function has been exhausted. This can correspond to an aspect of the LAPS method of FIG. 7, because the method can rely upon a corresponding hardware/firmware idle notification, as discussed above. For a short job, the hardware/firmware component can indicate that the virtual function is idling after approximately 1-2 ms of execution, for example. For a middle length job, the hardware/firmware component can indicate that the virtual function is idling after approximately 4-5 ms of execution, for example. For a long job, the hardware/firmware component might not necessarily indicate that the virtual function is idling and instead can indicate that the maximum time quanta has been exhausted, for example, and as further discussed above. And for a very light job, the hardware/firmware component can indicate that the virtual function is idling after approximately 1 ms, or the minimum time quanta, in which case the driver can allocate to the virtual function at least one millisecond time quanta, for example. In summary, the scheduler can schedule a frequency of granting a division of the resources to a particular virtual function based on a size of a respective submission from the first virtual function.

Once either of these trigger conditions has been satisfied at step 722, then execution of the virtual function can be stopped at step 724. Similarly, at step 726 the scheduler can update a last scheduling time for this particular virtual function. Lastly, the scheduler can increase the total actual execution time for this virtual function according to the virtual function's actual execution time of this round. The actual execution time of a particular round can correspond to the time marking the stopping of execution for the virtual function minus the time marking the switching of the hardware accelerator to this particular virtual function. This can correspond to another step of the LAPS method of FIG. 7. For a long job requested by a virtual function, the total actual execution time can increase in longer increments (e.g., can be 8-10 ms or longer), and then it can take a longer time for the total actual execution time for this virtual function to become the smallest total actual execution time, and therefore this particular virtual function can be scheduled more infrequently than others. In contrast, for a short job requested by a virtual function, the total actual execution time can increase in smaller increments (e.g., 1-2 ms), and then the total actual execution time for this virtual function can become the smallest total actual execution time more quickly, and therefore this virtual function can be scheduled more frequently.

In the above discussions of FIGS. 2-7, virtual functions have actual execution times in integers of milliseconds; yet in the real world, the precision of the total actual execution time could be calculated in microseconds. Similarly, the amount of actual execution time taken for the driver to indicate that the virtual function is idling and/or notifying to stop execution of the virtual function could be different from loop to loop. The examples of FIGS. 2-7 are, therefore, simplified to aid the reader in understanding.

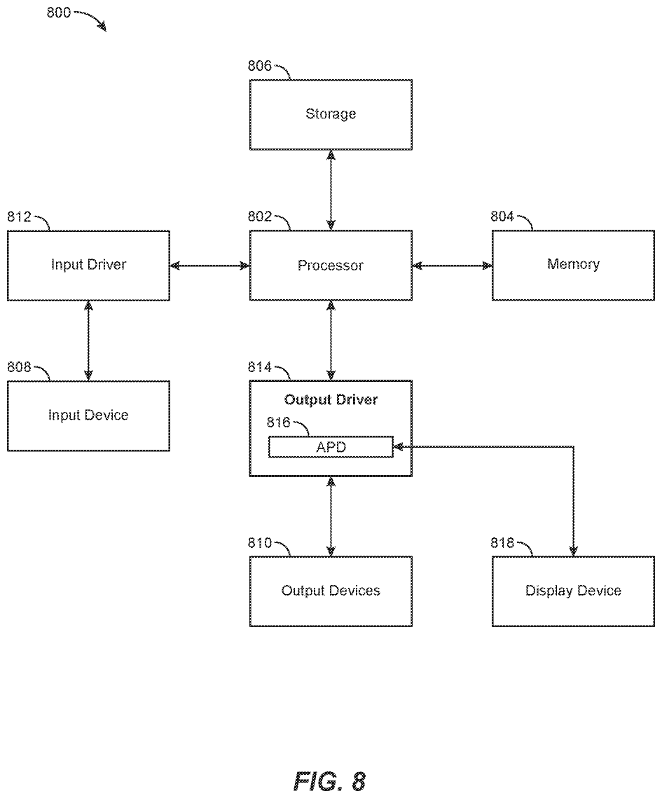

FIG. 8 is a block diagram of an example device 800 in which one or more features of the disclosure can be implemented. The device 800 can include, for example, a computer, a gaming device, a handheld device, a set-top box, a television, a mobile phone, or a tablet computer. The device 800 includes a processor 802 (which can also be referred to as a “host processor”), a memory 804, a storage 806, one or more input devices 808, and one or more output devices 810. The device 800 can also optionally include an input driver 812 and an output driver 814. It is understood that the device 800 can include additional components not shown in FIG. 8.

In various alternatives, the processor 802 includes a central processing unit (CPU), a graphics processing unit (GPU), a CPU and GPU located on the same die, or one or more processor cores, wherein each processor core can be a CPU or a GPU. In various alternatives, the memory 804 is be located on the same die as the processor 802, or is located separately from the processor 802. The memory 804 includes a volatile or non-volatile memory, for example, random access memory (RAM), dynamic RAM, or a cache.

The storage 806 includes a fixed or removable storage, for example, a hard disk drive, a solid state drive, an optical disk, or a flash drive. The input devices 808 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 810 include, without limitation, a display, a speaker, a printer, a haptic feedback device, one or more lights, an antenna, or a network connection (e.g., a wireless local area network card for transmission and/or reception of wireless IEEE 802 signals).

The input driver 812 communicates with the processor 802 and the input devices 808, and permits the processor 802 to receive input from the input devices 808. The output driver 814 communicates with the processor 802 and the output devices 810, and permits the processor 802 to send output to the output devices 810. It is noted that the input driver 812 and the output driver 814 are optional components, and that the device 800 will operate in the same manner if the Input driver 812 and the output driver 814 are not present. The output driver 814 includes an accelerated processing device (“APD”) 816 which is coupled to a display device 818. The APD is configured to accept compute commands and graphics rendering commands from processor 802, to process those compute and graphics rendering commands, and to provide pixel output to display device 818 for display. As described in further detail below, the APD 816 includes one or more parallel processing units configured to perform computations in accordance with a single-instruction-multiple-data (“SIMD”) paradigm. Thus, although various functionality is described herein as being performed by or in conjunction with the APD 816, in various alternatives, the functionality described as being performed by the APD 816 is additionally or alternatively performed by other computing devices having similar capabilities that are not driven by a host processor (e.g., processor 802) and configured to provide graphical output to a display device 818. For example, it is contemplated that any processing system that performs processing tasks in accordance with a SIMD paradigm can be configured to perform the functionality described herein. Alternatively, it is contemplated that computing systems that do not perform processing tasks in accordance with a SIMD paradigm performs the functionality described herein.

The processor 802 can be configured to support a virtualizations scheme in which multiple virtual machines execute on the processor 802. Each virtual machine (“VM”) “appears” to software executing in that VM as a completely “real” hardware computer system, but in reality comprises a virtualized computing environment that can be sharing the device 800 with other virtual machines. Virtualization can be supported fully in software, partially in hardware and partially in software, or fully in hardware. The APD 816 supports virtualization, meaning that the APD 816 can be shared among multiple virtual machines executing on the processor 802, with each VM “believing” that the VM has full ownership of a real, hardware APD 816.

FIG. 9 illustrates details of the device 800 and the APD 816 related to virtualization, according to an example. The processor 802 supports multiple virtual machines. A specialized host virtual machine 902, is not a “general purpose” VM like the guest VMs 904, but instead performs support for virtualization of the APD 816 for use by the guest VMs 904. A hypervisor 906 provides virtualization support for the virtual machines, which includes a wide variety of functions such as managing resources assigned to the virtual machines, spawning and killing virtual machines, handling system calls, managing access to peripheral devices, managing memory and page tables, and various other functions.

The APD 816 supports virtualization by allowing time-based sharing of the APD 816 between the virtual machines. On the APD 816, the host VM 902 is mapped to a physical function 908 and guest VMs 904 are mapped to virtual functions 910. “Physical functions” are essentially an addressing parameter in the peripheral component interconnect express (“PCIe”) standard. More specifically, physical functions allow communications involving a device coupled to a PCIe interconnect fabric to specify a particular physical function of the device so that the device is able to handle the communications according to functionality specifically assigned to that physical function. In one example, a physical function is associated with regular graphics rendering on a graphics processing device such as the APD 816. Herein, a single physical function is described, but the teachings of the present disclosure apply to APDs 816 for which more than one physical function is active.

Virtual functions are a feature of the PCIe standard that facilitates hardware virtualization and also act as an addressing parameter in the PCIe standard. Typically, a set of virtual functions is associated with a particular physical function. Each virtual machine is assigned a different virtual function, with the hypervisor 906 managing the correlation between VMs and virtual functions. This correlation between virtual functions and virtual machines 902 is mostly true in the system of FIG. 9, except that the host VM 902 is able to access the physical function 908 as well as any of the different virtual functions 910. In that sense, the host VM 902 acts as a sort of “master virtual machine” for APD virtualization. In some systems, the host VM 902 is not present, with the functions of the host VM 902 described herein performed by the hypervisor 906 instead. Note that although it is sometimes described herein that virtual functions are associated with virtual machines, it is also possible for the physical function to be associated with one or more virtual machines. Typically, the host VM 902 is considered to be “associated” with the physical function, and guest VMs 904 being associated with virtual functions. Because it is possible for virtual and physical functions to operate in a similar manner in some contexts, the term “function” within the specifier “virtual” or “physical” refers either to virtual functions or physical functions or to both virtual functions and physical functions collectively. For example, in some instances, it might be stated that the APD 816 time-shares operations between functions, which means that the APD 816 is time-shared among different virtual functions and, if actively participating in time-sharing on the APD 816, a physical function. It is not necessary for the physical function to participate in this time sharing, but it is possible for such the physical function to participate.

As described above, physical functions and virtual functions are addressing parameters in PCIe. Transactions over PCIe thus are associated with a physical function and optionally, additionally, a virtual function. Addressing over PCIe can be made explicitly, via a bus-device-function number paradigm, but this addressing paradigm is usually reserved for device configuration (e.g., PCIe device enumeration) or for other situations. More typically, and in standard operation, transactions over PCIe are made by memory address, with the PCIe fabric routing the transaction to an appropriate device and physical function and/or virtual function, based on a memory map. In this scenario, a VM would make an access to a memory address and the hypervisor or translation layer would translate the provided memory address, which is in guest physical memory address space, to an address in the system physical memory address space that is mapped to the APD 816. This translated address does not explicitly include an indication of a virtual function but is mapped to a particular virtual function via a memory map and is routed to that virtual function by the routing functionality of the PCIe fabric. Transactions over PCIe made via memory mapped addresses do not explicitly specify virtual or physical function numbers.

The present disclosure includes mention of guest and system physical address spaces. The relationship between these address spaces is now described. A system physical address space is the “true” physical address space of the device 800. The hypervisor 906 is able to access this address space, but this address space is hidden from VMs. A guest physical address space is the virtualized “physical” address space as “seen” by a particular guest VM 904. In other words, to a guest VM 904, a guest physical address space appears to be the actual physical address space. A third address space—guest virtual memory—represents the typical virtual memory address space that would exist in computer systems, but that exists in the virtualized environment of a VM. Mappings between the system physical address space and the guest physical address space are managed by the hypervisor 906 and mappings between the guest virtual address space and the guest physical address space are managed by the operating systems 820 although other parts of the device 800 (such as hardware-based page table walkers, translation caches, or other elements) can be involved in managing mappings between the different address spaces.

Sharing the APD 816 among the different virtual machines is accomplished by time-dividing the operations of the APD 816 among the different virtual machines, with different virtual functions (or the physical function) assigned to different virtual machines. A virtualization scheduler 912 performs work related to time-sharing the APD 816, scheduling a new virtual machine for operation by switching from work for a current virtual machine as the execution time assigned to that virtual machine elapses. Although the APD 816 is shared among the different virtual machines, each virtual machine perceives that it has an individual instance of a real, hardware APD 816.

Although the terms “virtual function” and “physical function” refer to addressing parameters of the PCIe standard, because these functions map to different VMs, the logical instance of an APD 816 assigned to a particular virtual machine will also be referred to herein as either a virtual function or a physical function. In other words, this disclosure can use terminology such as “the virtual function performs a task,” (or physical function) or “an operation is performed on or for a virtual function,” (or physical function) and this terminology should be read to mean that the APD 816 performs that task for the time-slice assigned to the VM associated with that particular virtual or physical function, or on behalf of the VM associated with that virtual or physical function.

The host VM 902 and the guest VMs 904 have operating systems 820. The host VM 902 has management applications 823 and an ADP virtualization driver 821. The scheduler of this application can be implemented as part of ADP virtualization driver 821 and/or within APD 816 (e.g., as part of virtualization scheduler 912). The guest VMs 904 have applications 826, an operating system 820, and an APD driver 822. These elements control various features of the operation of the processor 802 and the APD 816.

As stated above, the host VM 902 configures aspects of virtualization in the APD 816 for the guest VMs 904. Thus, the host VM 902 includes an operating system 820 that supports execution of other elements such as management applications 823. The management applications 823 perform one or more tasks for managing virtualization and/or that involve data from two or more different guest VMs 904. In one example, the host VM 902 performs a desktop compositing function through a management application 823, where the desktop compositing function has access to rendered frames from the different guest VMs 904 and composites those frames into a single output view.

The guest VMs 904 include an operating system 820, an APD driver 822, and applications 826. The operating system 820 is any type of operating system that could execute on processor 802. The APD driver 822 is a driver for the APD 816 in that the APD driver 822 controls operation of the APD 816 for the guest VM 904 on which the APD driver 822 is running, sending tasks such as graphics rendering tasks or other work to the APD 816 for processing. The native driver can be an unmodified or slightly modified version of a device driver for a APD that would exist in a bare-bones non-virtualized computing system.

The operating systems 820 of the host VM 902 and the guest VMs 904 perform standard functionality for operating systems in a virtualized environment, such as communicating with hardware, managing resources and a file system, managing virtual memory, managing a network stack, and many other functions. The APD driver 822 controls operation of the APD 816 for any particular guest VM 904 by, for example, providing an application programming interface (“API”) to software (e.g., applications 826) to access various functionality of the APD 816. The APD driver 822 also includes a just-in-time compiler that compiles programs for execution by processing components (such as the SIMD units 838 discussed in further detail below) of the APD 816. For any particular guest VM 904, the APD driver 822 controls functionality on the APD 816 related to that guest VM 904, and not for other VMs.

The APD 816 executes commands and programs for selected functions, such as graphics operations and non-graphics operations that can be suited for parallel processing. The APD 816 can be used for executing graphics pipeline operations such as pixel operations, geometric computations, and rendering an image to display device 818 based on commands received from the processor 802. The APD 816 also executes compute processing operations that are not directly related to graphics operations, such as operations related to video, physics simulations, computational fluid dynamics, or other tasks, based on commands received from the processor 802. A command processor 913 accepts commands from the processor 802 (or another source), and delegates tasks associated with those commands to the various elements of the APD 816 such as the graphics processing pipeline 834 and the compute units 832. The VMs inform the APD 816 regarding new tasks for execution via a doorbell mechanism, using the doorbell memory 914.

The APD 816 includes compute units 832 that include one or more SIMD units 838 that are configured to perform operations at the request of the processor 802 in a parallel manner according to a SIMD paradigm. The SIMD paradigm is one in which multiple processing elements share a single program control flow unit and program counter and thus execute the same program but are able to execute that program with different data. In one example, each SIMD unit 838 includes sixteen lanes, where each lane executes the same instruction at the same time as the other lanes in the SIMD unit 838 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 832 is a work-item. Each work-item represents a single instantiation of a program that is to be executed in parallel in a particular lane. Work-items can be executed simultaneously as a “wavefront” on a single SIMD processing unit 838. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 838 or partially or fully in parallel on different SIMD units 838. Wavefronts can be thought of as the largest collection of work-items that can be executed simultaneously on a single SIMD unit 838. Thus, if commands received from the processor 802 indicate that a particular program is to be parallelized to such a degree that the program cannot execute on a single SIMD unit 838 simultaneously, then that program is broken up into wavefronts which are parallelized on two or more SIMD units 838 or serialized on the same SIMD unit 838 (or both parallelized and serialized as needed). Command processor 913 can fetch a corresponding task and distribute it to graphics processing pipeline 834 or a compute unit 832.

The parallelism afforded by the compute units 832 is suitable for graphics related operations such as pixel value calculations, vertex transformations, and other graphics operations. Thus, in some instances, a graphics processing pipeline 834, which accepts graphics processing commands from the processor 802, provides computation tasks to the compute units 832 for execution in parallel.

The compute units 832 are also used to perform computation tasks not related to graphics or not performed as part of the “normal” operation of a graphics processing pipeline 834 (e.g., custom operations performed to supplement processing performed for operation of the graphics processing pipeline 834). Applications 826 or other software executing on the processor 802 transmit programs that define such computation tasks, such as a task 905, to the APD 816 for execution. For example, applications 826 that submit task 905 to APD 816 through driver 822.

Notifications that new work is ready to be performed on the APD 816 are made via a doorbell mechanism. More specifically, to notify the APD 816 that new work is ready, an entity (such as the processor 802) writes a doorbell into the doorbell memory 914. The doorbell includes a pointer into a command buffer that indicates the memory address of commands to be fetched and processed. Doorbell memory 914 can provide the mechanism by which APD driver 822 notifies APD 816 that task 905 has been submitted.

In one implementation, the doorbell includes the address of the head of a circular buffer. The address of the tail is maintained separately by the APD 816. When the head and tail pointers are equal, no new commands are available to be fetched. When an entity writes a doorbell including a head that is greater than the tail pointer, the commands to be fetched are found at addresses between the head and the tail. The APD 816 consumes the commands in the command buffer, adjusting the tail pointer as commands are fetched. When the head and tail pointers are again equal, no new commands are available in the command buffer. In this implementation, the doorbell serves both as a notification that work is ready to be performed and as an indication of the memory address at which commands are to be found. Optionally, doorbells written into the doorbell memory 914 are marked as processed when work indicated by that doorbell is complete or when a newer doorbell is written into the doorbell memory 914. In other implementations, the doorbell can serve only as an indication that work is ready to be fetched and executed, with indications of the locations of that work being determined separately from the value provided by the doorbell. In yet other implementations, the doorbell can serve any alternative or additional purpose.

The doorbell mechanism operates asynchronously with respect to which virtual machine is currently scheduled for work on the APD 816. This means that a particular virtual machine can place a doorbell in doorbell memory 914 at a time when tasks for a VM other than the VM that placed the doorbell in the doorbell memory 914 are being executed on the APD 816. This asynchronous operation occurs because doorbells are run by software executing on the processor 802 (e.g., software executing on the VMs), which software is scheduled independently as compared with the time-sliced work on the APD 816,

As described above, the virtualization scheduler 912 manages time-sharing of the APD 816 among the different virtual machines. In each time-slice, the virtualization scheduler 912 permits work for the virtual machine associated with that time-slice to proceed in the APD 816. The virtualization scheduler 912 manages time-slices on the APD 816 for the VMs (both the host VM 902 and the guest VMs 904) that share the APD 816. The virtualization scheduler 912 tracks the time-slices, stopping work on the APD 816 when a time-slice for a particular VM has expired and starting work for the VM having the next-time slice. Thus, the virtualization scheduler 912 switches between different VMs that have work to be executed on the APD 816. The act of switching between different VMs is referred to as a “virtualization context switch” herein. The virtualization scheduler selects different VMs to perform work based on a scheduling scheme. In one example, the scheduling scheme is a round robin scheme. In such a scheme, each VM is given a turn on the APD 816, with the order in which the VMs are given turns being repeated. Other technically feasible scheduling schemes are of course possible as well.

To begin work for a particular time-slice associated with a particular VM, the virtualization scheduler 912 causes the command processor 913 to fetch commands for the graphics processing pipeline 834 and/or for general purpose computing work from the address specified by the doorbell memory 914 for the particular VM. The command processor 913 then causes the APD 816 to execute those commands. The commands that are fetched are pointed to by doorbells stored in the doorbell memory 914.

When the virtualization scheduler 912 determines that the time-slice for the VM having work currently executing on the APD 816 has expired, the virtualization scheduler 912 causes the APD 816 to complete that work without accepting any new work (e.g., does not accept new tasks pointed to by a doorbell stored in the doorbell memory 914 but completes the tasks already “in flight” in the graphics processing pipeline 834 and/or compute units 838). Completing the work involves allowing the work currently in-flight in the APD 816 to complete and to have final output values written out to the target memory location. For example, for graphics rendering, output pixels would be written to the frame buffer (or other render target). Alternatively or in some situations, instead of completing tasks, state for the in-progress tasks can be saved and restored again when the function/VM again gets a “turn” on the APD 816.

After work has completed for a particular VM, the virtualization scheduler 912 moves on to the time-slice for the next VM, causing the command processor 913 to fetch tasks for that VM based on the contents of the doorbell memory 914, and to execute those tasks on the graphics processing pipeline 834 and/or in the compute units 832 directly (e.g., for general purpose computing). This process of stopping execution of work for a time slice that has expired and starting work for the next VM is performed repeatedly, in order to provide time-sharing of the APD 816 to the different VMs.

In addition to stopping work for one VM and starting work for another VM, a virtualization context switch also involves saving state for the VM that is being switched away from and loading state for the VM that is being switched to. Generally, state includes values stored throughout or for the APD 816 that manage aspects of the workflow executed for the APD 816. In various examples, state can include values stored in registers that control how graphics are rendered, how SIMD work is executed, how shaders are executed, and control of various other aspects of operations on the APD 816. Saving state involves writing the state from an in-use location (where the state values actually have effect on the operation of the APD 816) to a save state location for the VM. Loading state involves loading the state from the save state location for the VM to the in-use location. In some implementations, the save state location is in memory (such as a general purpose memory on the APD 816) and the in-use location includes various memory elements such as registers, special-purpose memory, and the like, within the APD 816.

Note that the other portions of the APD 816 with functionality that is not specifically described in the context of virtualization can still work as described above and as if no virtualization were occurring to execute the commands fetched by the command processor 913. For example, the graphics processing pipeline 834 performs operations related to graphics rendering in response to graphics rendering commands fetched by the command processor 913. The APD 816 can also include a per-VF firmware 932, which can be firmware that monitors a graphics processing idle state to notify the scheduler in accordance with FIG. 1 and FIG. 7.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system described herein can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of the example system herein can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

According to various implementations, all or a portion of the example system described herein can be implemented within a virtual environment. For example, the modules and/or data described herein can reside and/or execute within a virtual machine. As used herein, the term “virtual machine” generally refers to any operating system environment that is abstracted from computing hardware by a virtual machine manager (e.g., a hypervisor).

In some examples, all or a portion of the example systems described herein can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method for scheduling virtual functions, at least a portion of the method being performed by a computing device comprising at least one processor, the method comprising:
receiving a plurality of submissions from respective virtual functions requesting at least some resources from a hardware accelerator;
scheduling, by a scheduler, divisions of the resources to the respective virtual functions based on a total actual execution time slice of each respective virtual function; and
allocating the divisions of the resources to the respective virtual functions according to the schedule.

2. The method of claim 1, further comprising scheduling a first submission from a first virtual function based on the first virtual function having a lowest total actual execution time slice among the respective virtual functions.

3. The method of claim 1, further comprising scheduling a first submission from a first virtual function based on both the first virtual function having a smallest actual incremental time slice and a remainder of the virtual functions having the same total actual execution time slice.

4. The method of claim 1, further comprising scheduling a first submission from a first virtual function based on both the first virtual function having been scheduled first and based on a remainder of the virtual functions having the same total actual execution time and having the same detected incremental time slice.

5. The method of claim 1, wherein an actual incremental time slice for a first virtual function is ascertained by a hardware or firmware component.

6. The method of claim 5, wherein the hardware or firmware component reports the actual incremental time slice to the scheduler.

7. The method of claim 5, wherein the actual incremental time slice for the first virtual function deviates from a designated incremental time slice that was previously assigned to the first virtual function.

8. The method of claim 7, wherein the actual incremental time slice deviating from the designated incremental time slice causes the hardware accelerator to idle.

9. The method of claim 1, wherein the scheduler schedules a frequency of granting a division of the resources to a first virtual function based on a size of a respective submission from the first virtual function.

10. The method of claim 1, wherein the scheduler iteratively executes, during a cycle of the hardware accelerator, a function that updates the total actual execution time of each respective virtual function until a condition is met.

11. A hardware accelerator comprising:
a physical processor;
a non-transitory computer-readable memory storing instructions that, when executed by the physical processor, cause the hardware accelerator to perform a method comprising:
receiving a plurality of submissions from respective virtual functions requesting at least some resources from the hardware accelerator;
scheduling, by a scheduler in the hardware accelerator, divisions of the resources to the respective virtual functions based on a total actual execution time slice of each respective virtual function; and
allocating the divisions of the resources to the respective virtual functions according to the schedule.

12. The hardware accelerator of claim 11, wherein the method further comprises scheduling a first submission from a first virtual function based on the first virtual function having a lowest total actual execution time slice among the respective virtual functions.

13. The hardware accelerator of claim 11, wherein the method further comprises scheduling a first submission from a first virtual function based on both the first virtual function having a smallest actual incremental time slice and a remainder of the virtual functions having the same total actual execution time slice.

14. The hardware accelerator of claim 11, wherein the method further comprises scheduling a first submission from a first virtual function based on both the first virtual function having been scheduled first and based on a remainder of the virtual functions having the same total actual execution time and having the same detected incremental time slice.

15. The hardware accelerator of claim 11, wherein the instructions are configured such that an actual incremental time slice for a first virtual function is ascertained by a hardware or firmware component.

16. The hardware accelerator of claim 15, wherein the instructions are configured such that the scheduler receives a report of the actual incremental time slice from a hardware or firmware component.

17. The hardware accelerator of claim 15, wherein the actual incremental time slice for the first virtual function deviates from a designated incremental time slice that was previously assigned to the first virtual function.

18. The hardware accelerator of claim 17, wherein the actual incremental time slice deviating from the designated incremental time slice causes the hardware accelerator to idle.

19. The hardware accelerator of claim 11, wherein the instructions are configured such that the scheduler schedules a frequency of granting a division of the resources to a first virtual function based on a size of a respective submission from the first virtual function.

20. A non-transitory computer-readable medium comprising one or more computer-executable instructions that, when executed by at least one processor of a computing device, cause the computing device to perform a method comprising:
receiving a plurality of submissions from respective virtual functions requesting at least some resources from a hardware accelerator;
scheduling, by a scheduler, divisions of the resources to the respective virtual functions based on a total actual execution time slice of each respective virtual function; and
allocating the divisions of the resources to the respective virtual functions according to the schedule.
